(19) United States
(12) Patent Application Publication
(10) Pub. No.: US 2011/0065595 A1
(43) Pub. Date: Mar. 17, 2011

(54) Method and Test Kit for the Rapid Identification and Characterization of Cells

(76) Inventor: Nathan Citri, Jerusalem (IL)

(21) Appl. No.: 12/594,085

(22) PCT Filed: Apr. 10, 2008
(86) PCT No.: PCT/IL08/00495

§ 371 Date: Feb. 22, 2010

Related U.S. Application Data
(60) Provisional application No. 60/907,630, filed on Apr. 12, 2007.

(51) Int. Cl. C40B 30/04; C40B 40/04

(52) U.S. Cl. 506/9; 506/15

(57) ABSTRACT

The invention relates to a rapid method for the characterization and identification of prokaryotic or eukaryotic cells present in a test sample, using an enzyme characterizing a specific strain of cells as a dual marker for cell viability in the presence of a cell inhibitory agent, and as a structural marker for cell identification. The method of the invention is based on change in the enzymatic activity of the enzyme in a tested sample in the presence of different cell inhibitory agents and/or different recognition-agents, preferably, antibodies. The invention further provides kits for rapid characterization and identification of prokaryotic or eukaryotic cells present in a test sample.

### FIELD OF THE INVENTION

The present invention relates to a method and test kit for the rapid identification and characterization of cells. More particularly, the present invention relates to methods and test kits for the rapid characterization and identification of cells in a tested sample, using at least one characterizing enzyme expressed by said cells as a dual marker for cell-identity and for determining the sensitivity profile of said cells to various cell inhibitory agents.

### BACKGROUND OF THE INVENTION

Throughout this application, various publications, including United States patents, are referenced by author and year and patents by number. The disclosures of these publications and patents and patent applications in their entireties are hereby incorporated by reference into this application in order to more fully describe the state of the art to which this invention pertains.

The resistance of cells to inhibitory agents in general, and the resistance of bacteria to drugs such as antibiotics in particular, is a rapidly growing concern in the management of diseases such as microbial infections. Successful treatment of an infection depends on detection and identification of the pathogen and on the correct determination of its susceptibility to antibacterial drugs. It is essential that such information is available as soon as possible so, that appropriate treatment can be initiated without undue delays. Conventional procedures of identification require time consuming steps, such as cultivation for isolation of suspect colonies, followed by another step of cultivation for further identification and for evaluation of their susceptibility to antibiotics. Such slow and laborious procedures consume precious time, while information on the correct antibiotic treatment is not available. Thus, practitioners must decide whether to start antibiotic treatment before obtaining evidence whether the choice of the antibiotic is appropriate, bearing in mind that a wrong choice will confer advantage on pathogens resistant to said antibiotic.

Furthermore, in the present era, wherein the specter of germ warfare between countries, or as an isolated terrorist act, is a real and present danger, the ability to identify suspect cells on-the-spot and, at the same time, to determine their susceptibility to various antibiotics is a combined need that to date has not been met.

Many efforts have been made to reduce the time required for the identification of microbial pathogens and there are indeed several methods that meet this goal. The most valuable are methods that obviate the need for cultivation by making use of DNA probes or immunodiagnostic procedures which are rapid and most importantly, can be applied directly to a crude specimen. Thus, there is no shortage of acceptable solutions when identification of the pathogen is the only information that is of immediate relevance. However, as indicated above, there are very few exceptions to the rule that, in this age of alarming spread of drug-resistant microorganisms, identification alone is of little or no use without information on the susceptibility of the pathogen. So far, such susceptibility profiles could be determined only by following the conventional steps of isolating the pathogen and growing it in pure culture where its resistance to antibiotics can be determined on the basis of its ability to reach clearly visible growth at the end of one or more ‘overnight’ incubation steps.

U.S. Pat. No. 4,381,343 by the present inventor teaches that the presence of β-lactam antibiotics in test material such as food, infusions, vaccines, blood for transfusion, body fluids, etc., may be determined by seeding a nutrient medium with a β-lactamase generating bacterium or spores thereof, applying a sample of said test material to a site on the so-called nutrient medium, then incubating the medium under conditions inductive to the generation of β-lactamase by said bacteria and assaying the β-lactamase thus produced.

U.S. Pat. No. 5,614,371, also by the present inventor, discloses a method for the rapid detection of biotoxic contaminants in a test material comprising combining a sample of the test material with activated spores essentially devoid of detectable enzymatic activity, which activity becomes manifest and increases measurably following germination of the spores and with at least one germinant capable of triggering germination of the spores and a substrate which is catalytically convertible to a product by the enzymatic activity, incubating the mixture for a period less than one hour to accelerate germination of the spores, increase of the enzyme activity, and a catalytic conversion of the substrate, and detecting the formation of the product of the catalytic conversion of the substrate and the enzyme, the level of the product being maximal in the absence of any biotoxic contaminants, and decreasing in direct proportion to the toxicity of contaminants in the test sample.

The present invention aims at developing a rapid test and kit to be performed simultaneously with the detection and identification of the bacterial species or genus and to determine rapidly the bacterial resistance to antibiotics. The present invention thus provides a simple and rapid method that can supply combined information on both, the identity and the drug resistance profile of cells, such as bacteria, present in a tested specimen. The method of the present invention obviates the time-consuming steps of isolation and cultivation by applying a novel approach for identification and determination of drug resistance.

Therefore, one object of the invention is to provide a sensitive simple and rapid method for the characterization and identification of prokaryotic or eukaryotic cells present in a test sample, using an enzyme characterizing a specific strain of cells as a dual marker for the cell viability in the presence of a cell inhibitory agent, and as a structural marker for cell identification. The method of the invention comprises incubation of aliquots of a test sample with an array comprising at least one of: (i) different cell inhibitory agents forming plurality of mixtures and/or (ii) different recognition-agents, preferably, antibodies, that specifically recognize and bind an enzyme characterizing a particular strain of cells, and thereby enabling accurate identification of cells expressing such enzyme. These different recognition-agents form plurality of mixtures in the array. Subsequently, the levels of the enzymatic activity of said characterizing enzyme is next determined in each mixture comprised in the array. According to one embodiment, reduction in gain of enzymatic activity following incubation as compared to that of the appropriate control indicates that cells in the tested sample are sensitive to the cell inhibitory agent present in a certain mixture. Any change in the level of said catalytic activity as compared to a suitable control, in a sample contacted with a recognition-agent (for example, antibody) of (ii) indicates the specific recognition and binding of said characterizing enzyme by said recognition-agent and thereby provides the identification of said cell strain present in said tested sample.

Another object of the invention is to provide a kit for the rapid characterization and identification of prokaryotic or eukaryotic cells present in a test sample.

These and other objects of the invention will become apparent as the description proceeds.

### SUMMARY OF THE INVENTION

In a first aspect, the present invention relates to a method for the rapid characterization and the identification of prokaryotic or eukaryotic cells present in a test sample. The method of the invention is based on the use of at least one characterizing enzyme, expressed by particular cells as a functional marker for cell viability and as a structural marker for cell identification. Accordingly, the method of the invention comprises the steps of:

(a) providing an array comprising at least one of: (i) at least one cell inhibitory agent. Each of said inhibitory agents examined is located in a defined predetermined position in the array; (ii) at least one recognition-agent which specifically recognizes and binds said characterizing enzyme. Each one of the tested recognition-agents is specific for an enzyme characterizing a certain strain of cells and each of the recognition agents, is located in a defined position in said array. It should be understood that the array provided by the method of the invention may comprise the cell inhibitory agents, the recognition-agents, or both, the cell inhibitory agents and the recognition-agents;

(b) contacting aliquots of the test sample with each one of the agents present in array of (a), under conditions allowing enzyme formation and enzymatic activity of said characterizing enzyme; and

(c) determining the levels of said enzymatic activity in samples contacted with agents comprised in the array of (a) by measuring an end point indication by suitable means.

According to this embodiment, diminished increase in the level of said enzymatic activity as compared to a suitable control, in a sample contacted with a certain cell inhibitory agent located in a defined position in the array of (a), is indicative of sensitivity of the cells present in the tested sample, to said cell inhibitory agent. Thereby, the invention provides a sensitivity profiling of the cells in the tested sample to different cell inhibitory agents.

In each case where the identity of the cells is also examined, any change in the level of the catalytic activity of the enzyme as compared to a suitable control, in a sample contacted with a certain recognition-agent located in a defined position in the array of (a), indicates the specific recognition and binding of the characterizing enzyme by the recognition-agent. Recognition and binding of the specific recognition-agent, preferably, a cognate antibody, to the particular characterizing enzyme, may either interfere with or alternatively, enhance its catalytic activity, as reflected by an end-point indication. Therefore, any change in the catalytic activity indicates the presence of cells expressing the specific characterizing enzyme and therefore provides the identification of the cell strain present in the tested sample.

According to this embodiment, the method of the invention combines the identification and the characterization of sensitivity profile of a cell present in a tested sample to different cell inhibitory agents. However, it should be appreciated that the identification and the characterization may be performed simultaneously as in this particular embodiment, or independently or separately in either order.

Therefore, a further embodiment of the invention relates to a method for characterization of the sensitivity profile of cells in a given test sample to different cell inhibitory agents using a characterizing enzyme expressed by particular cells as a functional marker for cell viability.

In yet another embodiment, the invention provides a method for the rapid identification of prokaryotic or eukaryotic cells present in a test sample, using at least one characterizing enzyme expressed by particular cells as a structural marker for cell identification.

According to another aspect, the invention provides kits for the rapid characterization and identification of prokaryotic ‘or eukaryotic cells present in a test sample according to any, of the methods of the invention.

### DETAILED DESCRIPTION OF THE INVENTION

The present invention is based on the new concept of functional markers for characterization of cells in a tested sample, which permits the design of rapid and direct tests of sensitivity to potential inhibitors. The application of this concept, as illustrated in the examples cited below, eliminates the need for the hitherto essential steps of isolation and cultivation of the target cell. Functional marker as used herein, are molecules which can serve as vital signs of a cell, for instance by testifying to its biosynthetic capabilities. Functional markers are introduced here to be used, in an analogous way, for rapid determination of growth related parameters, including antibiotic susceptibility profiles.

The invention further provides an optional combination based on using the same functional markers as structural markers for identification of a certain cell strain. Structural markers as used herein are structural cell components or products, which provide specific epitopes that allow identification of a target cell by binding of antibodies.

Thus, in a first aspect, the present invention relates to a method that optionally combines the rapid characterization and the identification of prokaryotic or eukaryotic cells present in a test sample. The method of the invention is based on the use of at least one characterizing enzyme, expressed by particular cells as a functional marker for cell viability and as a structural marker for cell identification. Accordingly, the method of the invention comprising the steps of:

(a) providing an array comprising at least one of: (i) at least one cell inhibitory agent inhibiting cell growth. It should be noted that each of the cell inhibitory agents examined is located in a defined predetermined position in the array; (ii) at least one recognition-agent which specifically recognizes and binds said characterizing enzyme, and thereby leads to an alteration in its catalytic activity. Binding of the recognition-agent to the characterizing enzyme may therefore leads to either elevation, enhancement or increase in the catalytic activity, or alternatively, to interference and thereby to reduction or inhibition of the catalytic activity of the enzyme. It should be noted that each one of the tested recognition-agents is specific for an enzyme characterizing a certain strain of cells and each of said recognition-agents, is located in a defined predetermined position in the array. An array comprising both, the cell inhibitory agents and the recognition-agents enables the combination of determining the sensitivity profile of the cell as provided by the cell inhibitory agents of (i) with the identification of the certain cell strain present in the tested sample, as provided by the recognition agents of (ii). It should be understood that the array provided by the method of the invention may comprise any one of the cell inhibitory agents, the recognition agents, or both, the cell inhibitory agents and the recognition agents.

The next step (b) of the method of the invention involves contacting aliquots of the test sample with each one of the agents (cell inhibitory agents, recognition-agents or both) present in the array of (a), under conditions allowing enzyme formation and enzymatic activity of the characterizing enzyme. Subsequently, in step (c), the level of the enzymatic activity of the characterizing enzyme is determined in samples contacted with each one of the agents comprised in the array of (a) by measuring an end point indication using suitable means.

According to this embodiment, diminished increase in the level of the enzymatic activity as compared to a suitable control, in a sample contacted with a certain cell inhibitory agent located in a defined position in the array of (a), is indicative of sensitivity of the cells present in the tested sample, to said cell inhibitory agent. Thereby, the method of the invention provides a sensitivity profiling of the cells in the tested sample to each and every cell inhibitory agent examined in the array. Still further, according to this embodiment, any change observed in the level of the enzymatic activity as compared to a suitable control, in a sample contacted with a recognition-agent located in a defined position in the array of (a), indicates the specific recognition and binding of the characterizing enzyme by that recognition-agent. Such recognition and binding, alters the catalytic activity of the characterizing enzyme, and thereby either reduce or alternatively, elevate the levels of this activity or the stability of the enzyme as reflected by measuring an end point indication. Therefore, any change in the measured activity of the enzyme as compared to an appropriate control, indicates the presence of cells expressing the specific characterizing enzyme and thus provides the identification of the cell strain present in the tested sample. An end point indication may be an observed change in the levels of a detectable product, the level of a substrate of the catalytic reaction or in the rate of appearance or disappearance of either the product or the substrate.

According to one specific embodiment, a cell inhibitory agent as provided by the method of the invention may include any agent reducing, inhibiting or interfering with eukaryotic or prokaryotic cell viability, vitality or growth. Such agents may lead for example to cell death, including either necrotic cell death or apoptotic cell death, or alternatively may inhibit cell growth and division. Examples for cell inhibitory agents may include antibiotic agents as will be described in detail herein after. Alternatively, where the methods of the invention concern characterization of responsiveness of cancerous cells to different therapeutic agents, the cell inhibitory agent may be a chemotherapeutic agent. The main drugs used in anti-cancerous chemotherapy can be divided in four groups: cytotoxic agents, hormones, immune response modulators, and inhibitors of the tyrosin kinase activity.

Among cytotoxic agents, one can find cytotoxic antibiotics such as anthracyclins (doxorubicin, idarubicin, mitoxantrone which are apoptosis inducers). It should be noted that any chemotherapeutic agents of any of the described categories may be applicable by the method of the invention, as a cell inhibitory agent.

In yet another embodiment, the recognition-agent of (ii) used by the invention may be any agent that specifically recognizes and binds an enzyme characterizing a certain strain of cells. It should be appreciated that such recognition and binding must lead to an observed alteration or change in the catalytic activity of said enzyme. Such recognition-agent may be a protein based, carbohydrates based, lipid based, natural organic based, synthetically derived organic based, inorganic based material or any small molecule. According to one particular embodiment, the recognition-agent used by the methods and kits of the invention is an antibody specific for an enzyme characterizing a certain strain of cells. It should be noted that specific binding of said antibody to said characterizing enzyme changes the catalytic activity of said enzyme.

It should be noted that in said preferred embodiments, the characterizing enzyme may be used simultaneously as the identifying marker of cells present in a sample, and as viability marker reporting on the ability of said cells to de-novo synthesize and express said enzyme when exposed to various potential cell inhibitory agents. Furthermore, the steps of identification and sensitivity determination can be combined and the synthesis of a single endogenous enzyme can provide a combined structural and functional marker. An enzyme selected to play this dual role will be referred herein as a structural and functional marker (SF-marker). It will be further noted that the use of an endogenous enzyme as a marker provides a “built-in” amplification of the signal of binding of the recognition-agent, for example, antibody, a role analogous to that of an external enzyme which needs to be introduced in the design of standard enzyme immunoassays. And, uniquely, in the present invention the biosynthetic capability is similarly amplified by the catalytic activity of the functional marker.

According to one specific embodiment, the invention provides a combined method, for the rapid characterization and the identification of prokaryotic or eukaryotic cells present in a tested sample. The method of the invention is based on the use of at least one characterizing enzyme expressed by particular cells, as a functional marker for cell viability and as a structural marker for cell identification. Accordingly, the method of the invention comprising the steps of:

(a) providing an array comprising: (i) at least one cell inhibitory agent; and (ii) at least one recognition-agent, preferably, antibody which specifically recognizes said characterizing enzyme, and thereby changes its catalytic activity;

(b) contacting aliquots of the test sample with each one of the cell inhibitory agents and with each of the antibodies present in the array of (a), under conditions allowing enzyme formation and enzymatic activity of the characterizing enzyme; and

(c) determining the level of the enzymatic activity of the characterizing enzyme in samples contacted with any of the agents comprised in the array of (a) by measuring an end point indication using suitable means.

According to this embodiment, diminished increase in the level of the enzymatic activity as compared to a suitable control, in a sample contacted with a certain cell inhibitory agent located in a defined position in the array of (a), is indicative of sensitivity of the cells present in the tested sample, to said cell inhibitory agent. This provides a sensitivity profiling of the cells in the tested sample. Still further, any change, either reduction or elevation in the level of the enzymatic activity as compared to a suitable control, in samples contacted with a certain recognition-agent, preferably, antibody located in a defined position in the array of (a), indicates the specific recognition and binding of the characterizing enzyme by the certain cognate antibody. Such recognition and binding, alters or changes the catalytic activity of the enzyme, and thereby either reduces or alternatively, increases or enhances the levels, of activity as reflected by measuring an end point indication. Therefore, an observed alteration in the activity indicates the binding and thereby the presence of cells expressing the specific characterizing enzyme and thus provides the identification of the cell strain present in the tested sample.

According to these embodiments, the method of the invention optionally combines the identification and the characterization of sensitivity profile of a cell present in a tested sample to different cell inhibitory agents. However, it should be appreciated that the identification and the characterization may be performed simultaneously as in this particular embodiment, or independently or separately in either order.

Therefore, according to another embodiment, the invention provides a method for the rapid characterization and determination of sensitivity profile of prokaryotic or eukaryotic cells present in a test sample to different cell inhibitory agents. This method is based on the use of at least one characterizing enzyme expressed by particular cells, as functional marker for cell viability. The method of the invention therefore comprises the steps of:

(a) providing an array comprising at least one cell inhibitory agent. It should be noted that each of said cell inhibitory agents examined is located in a defined predetermined position in the array;

(b) contacting aliquots of the test sample with each one of the cell inhibitory agents present in the array of (a) under conditions allowing enzyme formation and enzymatic activity of the characterizing enzyme; and

(c) determining the levels of the enzymatic activity in samples contacted with the cell inhibitory agents array of (a) by an end point indication using suitable means.

According to one embodiment, diminished increase in the level of said enzymatic activity as compared to a suitable control, in a sample contacted with a certain cell inhibitory agent located in a defined position in the array of (a), is indicative of sensitivity of the cells present in the tested sample, to said cell inhibitory agent. Thereby, the method provides a sensitivity profiling of the cells in the tested sample to different cell inhibitory agents tested in the array.

As indicated above, identification of the cells present in a tested sample may be provided by using an enzyme characterizing a specific strain of cells as a structural marker. Therefore, a further embodiment of the invention relates to a method for the rapid identification of prokaryotic or eukaryotic cells present in a test sample. According to one embodiment, cells present in the tested sample express at least one characterizing enzyme. This method comprises the steps of:

(a) providing an array comprising at least one recognition-agent, preferably antibody, which specifically recognizes and binds the characterizing enzyme and thereby changes its catalytic activity. Each one of the tested antibodies is specific for an enzyme characterizing a certain strain of cells and each of said antibodies, is located in a defined position in said array;

(b) contacting aliquots of the test sample with each of the antibodies present in the array of (a) under conditions allowing the enzymatic activity of the characterizing enzyme; and

(c) determining the levels of the enzymatic activity in samples contacted with the antibodies comprised in the array of (a) by an end point indication using suitable means.

According to this embodiment, any change in the levels of the enzymatic activity as compared to a suitable control, in a sample contacted with a certain antibody or any other recognition-agent located in a defined position in the array of (a), indicates the specific recognition of the characterizing enzyme by the cognate antibody. Recognition and binding of that specific antibody to the particular characterizing enzyme, leads to an alteration, for example, interference and inhibition or alternatively, enhancement and elevation in the catalytic activity measured. The enzymatic activity may be determined by measuring an end point indication such as, amount of a detectable product, any detectable change in the amount of the substrate and/or the rate or the kinetic of the catalytic reaction. This provides the identification of the cell strain present in the tested sample.

The cell inhibitory agents and the antibodies used by the methods of the invention are arranged in an array. The term “array” as used by the methods and kits of the invention refers to an “addressed” spatial arrangement of the cell inhibitory agents of (i) and the recognition-agents, preferably, the antibodies of (ii). Each “address” of the array is a predetermined specific spatial region containing a known cell inhibitory agent or a known antibody. For example, an array may be a plurality of vessels (test tubes), plates (or even different predetermined locations in one plate, as demonstrated herein after by Example 4), micro-wells in a micro-plate each containing a different inhibitory agent or antibody. An array may also be any solid support holding in distinct regions (dots, lines, columns) different and known inhibitory agents or antibodies. The array preferably includes built-in appropriate controls, for example, regions without the sample, regions without any drug, regions without either, namely with solvent and reagents alone and regions containing the characterizing enzyme itself, or any other non-related enzyme (negative control). Solid support used for the array of the invention will be described in more detail herein after, in connection with the kits provided by the invention.

According to a specific embodiment, the methods of the invention further comprise the step of comparing the levels of the enzymatic activity of the characterizing enzyme to the levels of the enzymatic activity in an appropriate control. As shown by Example 1, an appropriate control may be the tested sample including the assay reagents, with no recognition-agents (such as antibodies) or cell inhibitory agents (antibiotics in this particular case). Alternatively or additionally, a positive control may be the enzyme used as the characterizing enzyme, provided in a purified or non-purified form. In certain embodiments, also non-related enzymes may be used as negative controls. Diminished increase in the level of said enzymatic activity of between about 10-100%, as compared to an appropriate positive control, may indicate that the growth or the viability of said cell has been inhibited by a specific cell inhibitory agent present in the array. Preferably, a decrease of at least 10%, at least 15%, at least 20%, at least 25%, at least 30%, at least 40%, at least 50%, at least 60%, at least 70%, at least 80%, at least 90%, or preferably by at least 95 or 100% in the enzymatic activity as compared to an appropriate control, reflects the amount of the enzyme formed in the presence of the cell inhibitory agent and thus indicate the sensitivity of said cell to a specific cell inhibitory agent present in the array.

In certain embodiments, where aliquots of the sample are contacted with different recognition-agents, for example; antibodies present in the array, any change or alteration of between about 10-100%, in the levels of the enzymatic activity as compared to an appropriate control indicates the recognition and binding. of said specific enzyme by said antibody. Thereby providing the identification of said cell strain present in the tested sample. Preferably, an alteration or more specifically, either reduction or elevation of at least 10%, at least 15%, at least 20%, at least 25%, at least 30%, at least 40%, at least 50%, at least 60%, at least 70%, at least 80%, at least 90%, or preferably by at least 95 or 100% in the enzymatic activity as compared to an appropriate control, indicates the recognition and binding of said specific enzyme by said antibody and thereby the identification of said cell strain present in said tested sample.

Example 1 illustrates a specific and non-limiting example for a combined identification and characterization of sensitivity profile of B. cereus to different antibiotic agents using beta-lactamase as an SF-marker. According to this embodiment, the enzymatic activity has been determined by measuring a change in the levels of the substrate as reflected by decolorization. As indicated by Table 1, a control sample showed decolorization after 47 seconds of reaction. Presence of the antibody in the reaction interfered with the rate of the reaction increasing the time needed for decolorization to 315 seconds (6.7 folds increase). This may indicate about 14.9% of the reaction or about 85% inhibition. Reaction in the presence of two different antibiotic agents, namely, Doxcyclin and Erythromycin significantly increased the time needed for decolorization in about 17.3 and 18 folds, respectively (815 and 850 seconds). This may reflect about 0.12% of the reaction or inhibition of about 99% of the enzymatic reaction.

Reference to “determining” as used by the methods of the present invention, includes estimating, quantifying, calculating or otherwise deriving a level of the enzymatic activity of the characterizing enzyme by measuring an end point indication that may be for example, the appearance of a detectable product, any detectable change in the substrate levels or any change in the rate of the appearance of the product or the disappearance of the substrate.

The term “identification” of a cell present in a sample may also be defining a particular microorganism or ascertaining the prevalence of a particular cell or microorganism at the genus or species level.

According to one embodiment, the method of the invention may be applicable for characterizing and optionally identifying prokaryotic as well as eukaryotic cells present in a test sample. Prokaryotic cells include bacteria and cyanobacteria (also known as blue-green algae). Eukaryotic cells include animal, plant, fungi and protists (protozoa, protophyta, slime molds and water molds).

According to a specifically referred embodiment, the method of the invention may be particularly suitable for characterizing and optionally identifying bacterial cells present in a tested sample.

It should be noted that the term “bacteria” is used in its broadest sense and includes Gram negative aerobic bacteria, Gram positive aerobic bacteria, Gram negative microaerophillic bacteria, Gram positive microaerophillic bacteria, Gram negative facultative anaerobic bacteria, Gram positive facultative anaerobic bacteria, Gram negative anaerobic bacteria, Gram positive anaerobic bacteria, Gram positive asporogenic bacteria and Actinomycetes.

It should be appreciated that the rapid method of the invention enables identification and characterization of cells intermixed within a tested sample and do not necessitate the time-consuming isolation of cells from the tested sample. It should be further evident that the more cells present in collected samples, the less time needed for completion of the identification. Therefore, according to another embodiment, the rapid characterization and identification of bacterial cells present in a tested sample by the methods of the invention may be completed within a period of between 180 to 30 minutes. More specifically, it should be noted that a period of between 180 to 30 minutes includes a period of 180, 170, 160, 150, 140, 130, 120, 110, 100, 90, 80, 70, 60, 50, 40 and 30, minutes.

The term “rapid” appears to have varying meanings to microbiologists. The literature lists many papers claiming rapid analysis techniques, where rapid is defined as less than twenty four hours. The present invention relates to the novel methods in which analysis requires less than three hours, preferably, less than two hours, and more preferably less than one hour.

According to one particular embodiment, the tested sample contains spores of bacterial cells. In such case “conditions allowing enzyme formation” as used herein, may include addition of a germinant capable of triggering germination of spores contained within the test sample. A non-limiting example for such germinant is L-alanine, as provided by Example 2.

According to another embodiment, where the tested sample comprises spores, the sample may be subjected to heat treatment that will activate the spores, thus facilitating their germination, while at the same time inactivating contaminating enzymes and vegetative cells prior to the assay thereof.

In order to rapidly react with the substrate and to determine cell growth in the presence of inhibitory agents (for example, antibiotic agents), the appropriate enzyme should be de-novo synthetized by the bacteria in an amount sufficient to catalyze the enzymatic activity to be measured by an end point indication. The amount of enzyme required to achieve this result depends, among other things, on the desired speed of release of the detectable product or the change in the amount of the substrate, and on the sensitivity of the detection system. However, bacterial enzymes may be constitutive or inducible. Unlike constitutive enzymes the enzymes termed “inducible” are synthesized at a very low, often hardly detectable rate unless induced, namely exposed to the specific inducer, a compound usually structurally related, or even identical to the substrate. In such inducible systems, it is obviously necessary to induce the production of the enzyme to the desired detectable level. Thus, according tₒ another specific embodiment, where the characterizing enzyme is used as a functional marker for cell viability, conditions suitable for enzyme formation will include addition of at least one inducer for induction of the expression of said characterizing enzymes by said cells. Production of the enzyme can be induced by any of several suitable chemical agents such as beta-lactam antibiotics, for example, cloxacillin and penicillin V as used in Example 1, where the characterizing enzyme is beta-lactamase. It should be noted that any beta-lactam antibiotic indicated herein after may be used by the method of the invention as an inducing agent. Agents such as lactose, may be used as inducers where the characterizing enzyme is beta-galactosidase. Among the chemical inducers are the galactosides that are also substrates for the enzyme. Suitable inducing agents for beta-galactosidase include methyl-β-thiogalactoside and isopropyl thio β-D-galactopyranoside. This can be done rapidly, generally in less than 15 minutes.

Still further, “suitable conditions for enzyme formation and enzymatic activity” as used herein include in addition to the use of inducers, the use of an appropriate growth medium or any growth conditions (for example, aerobic or anaerobic environment) enabling growth of bacterial cells contained within the tested sample, and appropriate incubation time of the sample with the enzyme inducer, for example, 1, 2, 3, 4, 5, 6, 7, 8, 9, 10, 15, 20 minutes of incubation. Suitable conditions further include addition of suitable reagents for enabling enzymatic reaction and suitable reagents for detection of an end point indication. An end-point indication may reflect any change in the amount of the substrate, appearance of the detectable product or the rate of the change in the amount of the substrate or the product.

In preferred embodiments of the present invention, the selection of an endogenous enzyme as a functional marker for cell viability and optionally as a structural marker for cell identification may be advantageous if based on the following considerations:

(a) The catalytic activity of the characterizing enzyme should be easy to determine, preferably by direct visual inspection and/or by an optical reader.

(b) The characterizing enzyme is, or can be readily made, accessible to a specific antibody. Preferably, such enzyme may be a secreted enzyme or at least a readily releasable enzyme.

(c) The effect of the antibody on the catalytic properties of the characterizing enzyme is easy to determine, preferably by direct determination, e.g. neutralization, namely reduction of the enzymatic activity, or alternatively, elevation of such enzymatic activity.

It should be understood that a nucleic acid sequence encoding the characterizing enzyme may be either chromosomal or extra-chromosomal, namely, plasmid DNA. Therefore, it goes without saying that if the selected characterizing enzyme is encoded by a plasmid, the recognizing-agent will recognize the cell as a cell carrying said plasmid.

According to one specific embodiment, the characterizing enzyme used as a functional and optionally, as a structural marker by the methods of the invention, may be any bacterial enzyme, for example, an enzyme selected from the group consisting of: beta-lactamase, alpha-amylase, beta-glucosidase, alpha-glucosidase, catalase, lipase, beta-xylosidase, beta-glucuronidase, beta-galactosidase, chondroitinsulfatase, gelatinase, collagenase and caseinase. It should be noted that other enzymes known to be found in various bacterial species may be also used as characterizing enzymes, for example, Phosphotransferase, Zinc dependent phospholipase C, betaine-aldehyde dehydrogenase, chitinase, Serine-type D-Ala-D -Ala carboxypeptidase, Subtilisin, Maltose-transporting ATPase, 2,5-didehydrogluconate reductase, Phospholipase C, Serine-type D-Ala-D-Ala carboxypeptidase, Zinc D-Ala-D-Ala carboxypeptidase, Beta-diketone hydrolase, Glucan 1,4-alpha-glucosidase, Pullulanase, Cyclomaltodextrin glucanotransferase, N-acetyl-beta-glucosaminidase and L-lactate dehydrogenase.

According to one specific embodiment, the characterizing enzyme used for the methods of the invention may be the beta-lactamase.

Beta-lactamase production is an important mechanism of resistance to beta-lactam antibiotics that has been observed in most bacterial species. Beta-lactamases hydrolyze the beta-lactam ring in a susceptible beta-lactam antibiotic, thus destroying its antibacterial activity.

β-lactamase classification into four molecular classes (A, B, C and D) is based on their amino acid sequences. Class A enzymes have a molecular weight of about 29 kDa and preferentially hydrolyze penicillins. Examples of class A enzymes include RTEM and the β-lactamase of Staphylococcus aureus. Class B enzymes include metalloenzymes that have a broader substrate profile than the other classes of β-lactamases. Class C enzymes have molecular weights of approximately 39 kDa and include the chromosomal cephalosporinases of gram-negative bacteria, which are responsible for the resistance of gram-negative bacteria to a variety of both traditional and newly designed antibiotics. In addition, class C enzymes also include the lactamase of P99 Enterobacter cloacae, which is responsible for making this Enterobacter species one of the most widely spread bacterial agents in United States hospitals. The recently recognized class D enzymes are serine hydrolases, which exhibit a unique substrate profile.

Several methods for detecting the presence of microbial beta-lactamase have been developed. For example, chemical methods for the detection of the enzymatic hydrolysis of the beta-lactam ring include: (a) the acidimetric method, which employs a color indicator to detect the decrease in pH resulting from the formation of a new carboxyl group; (b) the iodometric method, which is based on the decolorization of a starch-iodine complex by the end products of beta-lactamase hydrolysis, which act as reducing agents to reduce iodine in the complex; and (c) the chromogonic cephalosporin method, which is based on a color change following the hydrolysis of a chromogenic cephalosporin substrate.

Another method that has been utilized for detecting β-lactamase activity uses pairs of fluorescent donor and quencher dyes coupled to a cephalosporin ring system. In the intact substrate, the close proximity and optical characteristics of the dyes result in fluorescence resonance energy transfer (FRET) between an excited donor dye and the acceptor dye, thereby masking the fluorescence of the donor dye. Cleavage of the β-lactam portion of the cephalosporin ring by a β-lactamase initiates a reaction that allows the donor and quencher dyes to separate by a distance that reduces or eliminates FRET. Once separated, quenching of the donor dye's fluorescence is relieved and the donor dye's fluorescence may be detected as an indicator of β-lactamase activity. FRET-based β-lactamase substrates for detection of β-lactamase activity are disclosed, for example, in U.S. Pat. No. 5,741,657.

In principle, any sensitive and convenient method described above can be applicable. The most familiar are colorimetric methods based on pH indicator dyes reporting the catalytic conversion of a beta-lactam derivative to the corresponding acid. According to one embodiment, preferable assays in terms of sensitivity and clarity are the iodometric methods based on the uptake of iodine by the products of the catalytic breakdown of all known beta-lactam antibiotics, as specifically described in the following examples. It should be further appreciated that determination of beta lactamase activity may be done automatically, as in the iodometric methods where the reaction produces visually striking decolorization that can be easily scanned and recorded or analyzed by an image analyzer. Thus, according to this particular embodiment, an end point indication may be de-colorization that reflects reduction in the amount of the substrate.

As shown by Example 1, the invention provides the use of antibodies specific for beta-lactamase derived from Bacillus cereus as a structural-functional marker (SF-marker) for identification and profiling of antibiotic- sensitivity of this particular strain in a tested sample. Thus, according to one specific embodiment, the invention provides the identification and characterization of sensitivity profile of Bacillus cereus in a tested sample.

It will be noted that the closest relative of Bacillus cereus is the causative agent of anthrax, namely the spore-forming bacterium Bacillus anthracis.

Anthrax is an acute infectious disease most commonly occurs in wild and domestic lower vertebrates (cattle, sheep, goats, camels, antelopes, and other herbivores), but it can also occur in humans when they are exposed to infected animals or tissue from infected animals. Pulmonary infections are by far the most life-threatening and provide the basis for using spores of Bacillus anthracis as the leading biological mass destruction weapon, in biological warfare and in acts of bioterrorism. The “weaponized” spores are known to have been engineered for multiple drug resistance as well as for facilitated infectivity by inhalation.

Currently, Anthrax is diagnosed by culture and isolation of the causative bacterium, Bacillus anthracis, by detecting the bacterial DNA or antigens, or by measuring specific antibodies in the blood of persons with suspected cases.

It is not surprising that engineered strains of Bacillus anthracis have been rendered resistant to many drugs that might otherwise prevent the disastrous consequences of inhaling the germs. It has been established that prevention will be effective if the right antibiotic is administered within two hours of exposure to the bioengineered spores. However, the sensitivity profile of any such strain is unpredictable except for the fact that Bacillus anthracis, like Bacillus cereus uses beta-lactamase for defense against penicillin to which both species are otherwise very sensitive.

What follows is that the test described in Example 1, can be directly applied for the identification and the establishment of the drug sensitivity profile of an unknown variant of Bacillus anthracis. This information should enable initiation of evidence-based treatment well within the two-hour window and days before it is currently possible to secure.

Thus, according to another embodiment, the invention provides the use of beta-lactamase that is a characterizing enzyme for Bacillus anthracis, as a structural and most importantly, a functional marker for the rapid detection and characterization of Anthrax in a tested sample and for sensitivity profiling of the strain in a sample to different antibiotic agents.

As shown by Example 2, the invention provides the use of alpha-amylase formed by Bacillus subtilis as a structural-functional marker for identification and profiling of antibiotic-sensitivity of this particular strain in a tested sample. Thus, according to another specific embodiment, the invention relates to identification and characterization of sensitivity profile of Bacillus subtilis in a tested sample.

Members of the Enterobacteriaceae family are grain negative and lactose fermenting. These bacteria are classified as coliform bacteria, without attempting further classification. Of the species meeting these criteria members of the genus Escherichia are the most common, with Escherichia coli predominant. β-D-galactosidase is a key enzyme permitting coliform bacteria to react with galactosides such as lactose, i.e., lactose β-D-galactosidase galactose +glucose. Thus, another embodiment of the invention provides a method for detection and characterization of Enterobacteriaceae family, specifically, the coliform bacteria, and more specifically, the Escherichia coli, in a sample, using the β-D-galactosidase, as a characterizing enzyme.

Infections due to anaerobes are common and associated with considerable morbidity and potential mortality. Anaerobic gram-negative bacteria (AGNB) belonging to the genera Bacteroides, Prevotella and Porphyromonas are most commonly encountered in clinical infections. AGNB produce enzymes that play a significant role in the development of disease. For example, AGNB isolates such as Bacteroides fragilis and Porphyromonas gingivalis, commonly produced caseinase, collagenase and haemolysin. Comparatively larger number of clinical AGNB produced collagenase.

There is some evidence that hydrolytic and proteolytic enzymes like chondroitinsulfatase, gelatinase, collagenase, catalase, caseinase, haemolysin, hyaluronidase and lipase secreted by AGNB play a role in the infectious process. In the light of the above facts, the diagnostic potential of such characterizing enzymes is clear. Thus, according to another embodiment, the present invention further provides the use of such enzymes, and particularly any one of collagenase, caseinase and gelatinase, as functional and structural markers for AGNB.

Caseinase producing AGNB on casein-containing medium produce zones of clearance beneath and around the areas of growth due to the digestion of casein.

For gelatinase production test, the samples may be inoculates into 0.4% gelatin agar. After satisfactory growth, mercuric chloride solution is added, which rapidly denatures and renders opaque any unhydrolyzed gelatin. Lipolytic organisms produce a restricted opacity and pearly layer on egg yolk medium. Hemolysin production may be tested by adding the tested sample to a red blood cell suspension.

As indicated above, determination of the identity and sensitivity of specific bacterial cells is performed by using a characterizing enzyme expressed by the cells as a functional and a structural marker. Detection of activity of the enzyme in a sample indicates the identity of the cells in the sample and the sensitivity or resistance of the cells to an inhibitory agent such as an antibiotic. Gain in activity level of the enzyme reflects viability of the cells expressing de novo synthesized enzyme, and may be measured by determining an end point indication. Such indication may be or may reflects the appearance of a detectable product, a detectable change in the levels of the substrate, or the rate of the appearance or change in the levels of the product or the substrate, respectively.

The term “detectable product” as used herein refers to a product causing an occurrence of, or a change in, a signal that is directly or indirectly detectable (observable) either by visual observation or by instrumentation. Typically, the detectable product is detectable in an optical property (“optically detectable”) as reflected by a change in the wavelength distribution patterns or intensity of absorbance or fluorescence or a change in light scatter, fluorescence lifetime, fluorescence polarization, or a combination of such parameters in a sample.

It should be appreciated that also the substrate or any products thereof should be directly or indirectly detectable in the same manner.

The term “detectable” as used herein refers to the presence of a detectable label or the signal generated from a detectable label that is immediately detectable by observation, instrumentation, or film.

According to one specific embodiment, where the cells to be detected in a sample are bacterial cells, the inhibitory agent used for characterizing the sensitivity profile of the cells may be antibiotic agents. It should be noted that any antibacterial antibiotic agents are applicable by any of the methods and the kits of the invention.

Known antibacterial agents include low-molecular weight agents that are produced as secondary metabolites by certain groups of micro-organisms, especially Streptomyces, Bacillus, and a few molds (Penicillium and Cephalosporium) that are inhabitants of soils. These antibacterial agents may have a bactericidal effect or a static effect on a range of micro-organisms.

Antibacterial agents that have already been identified also include chemotherapeutic agents which are chemically synthesized, as well as semi-synthetic antibiotics, wherein an antibacterial agent that is naturally produced by a micro-organism is subsequently modified by chemical methods to achieve desired properties.

Antibacterial agents achieve their bactericidal or static effects by altering various metabolic pathways of the target micro- organisms.

Several antibacterial agents act as cell membrane inhibitors that disorganize the structure or inhibit the function of bacterial membranes, like polymyxin B, which binds to membrane phospholipids and thereby interferes with membrane function, mainly against Gram-negative bacteria.

Several other antibacterial agents act as protein synthesis inhibitors, like tetracyclines, chloramphenicol, macrolides and aminoglycosides.

Still other antibacterial substances affect the synthesis of DNA or DNA, or can bind to DNA or RNA, like quinolones and rifamycins.

Yet other antibacterial substances act as competitive inhibitors of essential metabolites or growth factors, like sulfonamides.

Important antibacterial substances act as inhibitors of the cell wall synthesis, and more specifically, as inhibitors of the synthesis of the bacterial peptidoglycan. The peptidoglycan is a macromolecular structure found on the outer face of the cytoplasmic membrane of almost all bacteria. This structure is of importance for the maintenance of the integrity of the bacteria and for the cell division process. Peptidoglycan synthesis inhibitors exert their selective toxicity against eubacteria, since mammal cells lack peptidoglycan.

The main inhibitors of the cell wall synthesis are those of the beta lactam family, which include penicillins and cephalosporins. The beta lactam antibiotic's are stereochemically related to D-alanyl-D-alanine which is a substrate for the last step in peptidoglycan synthesis, i.e. the final cross-linking between peptide side chains. Beta lactam compounds include natural and semi-synthetic penicillins, clavulanic acid, cephalosporins, carbapeneins and monobactams. Other inhibitors also encompass glycopeptides such as vancomycin.

More specifically, β-lactam antibiotics include several groups, for example the Penicillins, Cephalosporins, Carbapenems, Monobactams and Beta-lactamase inhibitors. Each group may be divided to different categories, for example the the Penicillins may include narrow spectrum pinicillins, such as, benzathine penicillin, benzylpenicillin (penicillin G), phenoxymethylpenicillin (penicillin V), procaine penicillin and oxacillin. Narrow spectrum penicillinase-resistant penicillins, include methicillin, dicloxacillin and flucloxacillin. The narrow spectrum β-lactamase-resistant penicillins may include temocillin. The moderate spectrum penicillins are, for example, amoxycillin and ampicillin. The broad spectrum penicillins include the co-amoxiclav (amoxycillin+clavulanic acid). And finally, the penicillin group also includes the extended spectrum penicillins, for example, azlocillin, carbenicillin, ticarcillin, mezlocillin and piperacillin

Another group of β-lactam antibiotics include Cephalosporins. First generation cephalosporins, also considered as the moderate spectrum include cephalexin, cephalothin and cefazolin. Second generation cephalosporins that are considered as having moderate spectrum with anti-Haemophilus activity may include cefaclor, cefuroxime and cefamandole. Second generation cephamycins that exhibit moderate spectrum with anti-anaerobic activity include cefotetan and cefoxitin. Third generation cephalosporins considered as having broad spectrum of activity include ceftriaxone, cefotaxime and cefpodoxime. Broad spectrum with anti-Pseudomonas activity include the ceftazidime. Finally, the fourth generation cephalosporins considered as broad spectrum with enhanced activity against Gram positive bacteria and beta-lactamase stability include the cefepime and cefpirome.

Another group of β-lactam antibiotics include Carbapenems that are considered as the broadest spectrum of beta-lactam antibiotics. This group includes imipenem (with cilastatin), meropenem, ertapenem, faropenem and doripenem.

Another group of β-lactam antibiotics is the Monobactams such as aztreonam Unlike other beta-lactams, the monobactam contains a nucleus with no fused ring attached. Thus, there is less probability of cross-sensitivity reactions.

Another group of β-lactam antibiotics is the Beta-lactamase inhibitors, for example, clavulanic acid. Although they exhibit negligible antimicrobial activity, they contain the beta-lactam ring. Their sole purpose is to prevent the inactivation of beta-lactam antibiotics by binding the beta-lactamases, and, as such, they are co-administered with beta-lactam antibiotics. As indicated above, for identification of the cells, preferably, bacterial cells in a tested sample, the method of the invention uses the characterizing enzyme as a structural marker. For detection, the sample or any aliquots thereof, is inoculated and contacted with an array, carrying at least one recognition-agent, specifically, antibody, in a predetermined separate location. As indicated before, the antibody used should recognize specifically an enzyme characterizing a certain strain of cells. Furthermore, the antibody used specifically bind the characterizing enzyme, and thereby alters or changes its catalytic activity. It should be appreciated that an alteration or a change in the catalytic activity of the characterizing enzyme include interference and thereby inhibition or reduction of the catalytic activity as compared to an appropriate control. Alternatively, an alteration or change may be enhancement, elevation, or increase in the catalytic activity measured. It should be further noted that a “change” in the catalytic activity caused by binding of the antibody may also reflects or indicates any change in the kinetics or in the rate of such reaction. Accordingly, binding of the antibody to the enzyme, may induce a conformational change leading to either stabilization or de-stabilization of the enzyme. Binding of the antibody to the enzyme may also increased or decreased recognition of the substrate by the enzyme, affecting the rate of the reaction.

The term “antibody” as used herein refers to an immunoglobulin molecule or immunologically active portion thereof, i.e., an antigen-binding portion. Examples of immunologically active portions of immunoglobulin molecules include F(ab) and F(ab′)₂ fragments, which retain the ability to bind their specific epitope. Such fragments can be obtained commercially or using methods known in the art. For example F(ab)₂ fragments can be generated by treating the antibody with an enzyme such as pepsin, a non-specific endopeptidase that normally produces one F(ab)₂ fragment and numerous small peptides of the Fc portion.

It should be noted that any antibody used by the methods and kits of the invention may be a polyclonal, monoclonal, recombinant, e.g., a chimeric, or single chain antibody (ScFv).

It should be appreciated that whereas it is theoretically possible to assay intact samples, the catalytic activity that is measured by the methods and kits of the invention is likely to be too slow for most practical purposes. Concentrating some of the bacteria present in the clinical specimen may be thus, a preliminary part of the test. That step may be as simple as a two minutes centrifugation or sedimentation [e.g. by adsorption on a Ca-phosphate derived precipitant] or filtration of the bacterial contents of a 1-2 ml portion of the specimen. Alternatively, the filter membrane can be mounted on an absorbent layer forming part of a disposable assay unit.

The term “sample” in the present specification and claims is used herein in its broadest sense. It is meant to include both biological and environmental samples. A sample may include a specimen of natural or synthetic origin. Biological samples may be obtained from animal, including human, fluid, solid (e.g., stool) or tissue, as well as liquid and solid food and feed products and ingredients such as dairy items, vegetables, meat and meat by-products, and waste.

The term “sample” may also include body fluids (urine, blood, milk, cerebrospinal fluid, rinse fluid obtained from wash of body cavities, phlegm, pus), swabs taken from suspected body regions (throat, vagina, ear, eye, skin, sores), food products (both solids and fluids), swabs taken from medicinal instruments, apparatus, materials) samples taken from air (for airborne bacteria especially from ventilation systems), samples taken from the environment (soil, water, plant parts). Typically swabs and samples that are a priori not liquid are contacted with a liquid medium which is contacted with the array (the antibiotic or the antibody arrays).

Biological samples may be obtained from all of the various families of domestic animals, as well as feral or wild animals, including, but not limited to, such animals as ungulates, bear, fish, lagamorphs, rodents, etc.

Environmental samples include environmental material such as surface matter and industrial samples. Samples from natural environments such as soil, river, hot mineral water springs, plant, antarctic, air or extraterrestrial samples as well as samples from industrial sites such as waste sites and areas of oil spills or aromatic or complex molecule contamination and pesticide contamination. The sample may also comprise food, food components, food derivatives and/or food ingredients including food products formed in the dairy industry such as milk. The term “sample” may also include samples obtained from food and dairy processing instruments, apparatus, equipment, utensils, hospital beds and beddings, door knobs and handles, disposable and non-disposable items. It should be appreciated that the sample may be liquid, solid, slurry, air, vapour, droplet or aerosol or a combination of any of the above.

These examples are not to be construed as limiting the sample types applicable to the methods and kits of the present invention.

Another aspect of the invention relates to a kit for the rapid characterization and identification of prokaryotic or eukaryotic cells present in a test sample. The kit of the invention is based on the use of at least one characterizing enzyme, expressed by particular cells as functional marker for cell viability and as a structural marker for cell identification. According to one embodiment, the kit of the invention comprises:

(a) at least one means for collecting a sample to be tested;

(b) at least one compartment containing an array comprising at least one of:
(i) at least one cell inhibitory agent. Each of said cell inhibitory agents examined is located in a defined predetermined position in the array; and
(ii) at least one recognition-agent which specifically recognizes and binds said characterizing enzyme. Each one of the tested recognition-agents is specific for an enzyme characterizing a certain strain of cells and each of said recognition-agents, is located in a defined position in said array. This ingredient of the kit of the invention enables the combination of the sensitivity profile of the cell, with the identification of the certain cell strain present in the tested sample;

(c) at least one compartment containing at least one reagent necessary for enzyme formation for- example, germinants or inducers and the standard culture medium appropriate for the cells to be tested for;

(d) at least one assay reagent for enabling detection of the catalytic activity of said characterizing enzyme, for example, detecting the formation of a detectable product or detecting the change in the level of the substrate;

(e) optionally, the kit of the invention may comprise at least one control sample; and

(f) at least one means for detecting the catalytic activity of said enzyme (for example, by measuring the product or the substrate of the characterizing enzyme).

According to a specifically preferred embodiment, the invention provides kits for the rapid characterization and identification of prokaryotic or eukaryotic cells present in a test sample according to any of the methods of the invention. It should be appreciated that the use of one enzyme as a dual structural-functional marker is particularly advantageous since it requires the performance of one enzymatic reaction. This advantage is also reflected by a simple kit having less reagents required for enzymatic reaction.

According to one embodiment, the present invention further provides kits for the rapid characterization, namely profiling of the sensitivity of prokaryotic or eukaryotic cells present in a test sample to different cell inhibitory agents. The kit of the invention is based on the use of at least one characterizing enzyme, expressed by particular cells as functional marker for cell viability. According to this embodiment, the kits of the invention may comprise:

(a) at least one means for collecting a sample to be tested;

(b) at least one compartment containing an array comprising at least one cell inhibitory agent. Each of said inhibitory agents examined is located in a defined predetermined position in the array;

(c) at least one compartment containing at least one reagent necessary for enzyme formation and reagent necessary for enzymatic activity;

(d) at least one compartment containing at least one assay reagent for enabling detection of the catalytic activity of said characterizing enzyme, for example by measuring the formation of a detectable product or by determining the change in the amount of the substrate of said characterizing enzyme;

(e) optionally, the kit of the invention may comprise at least one control sample; and

(f) at least one means for detecting and determining the catalytic activity, the product of the characterizing enzyme or the change in the substrate.

In yet another alternative embodiment, the invention provides a kit for identification of prokaryotic or eukaryotic cells present in a test sample. The kit of the invention is based on the use of at least one characterizing enzyme, expressed by particular cells as a structural marker for cell identification.

According to this embodiment, the kit of the invention comprises:

(a) at least one means for collecting a sample to be tested;

(b) at least one compartment containing an array comprising at least one recognition-agent, preferably, antibody which specifically recognizes and binds said characterizing enzyme. Each one of the tested recognition-agents (antibodies) is specific for an enzyme characterizing a certain strain of cells and each of said antibodies, is located in a defined position in said array;

(c) at least one compartment containing at least one reagent necessary for enzymatic activity;

(d) at least one compartment containing at least one assay reagent for enabling detection of the catalytic activity of said characterizing enzyme, for example, formation of a detectable product or a change in the amount of the substrate;

(e) optionally, the kit of the invention may comprise at least one control sample; and

(f) at least one means for detecting the catalytic activity of the characterizing enzyme (for example, means for detecting the product or a change in the substrate).

According to one embodiment, the kits provided by the present invention are specifically applicable for detecting bacterial cells in a given tested sample. In yet another specific embodiment, the invention provides kits for characterizing a sensitivity profile of a bacterial cell in a tested sample, to different antibiotic agents. Accordingly, the kit of the invention may include as a cell inhibitory agent comprised in the array, different antibiotic agents. It should be appreciated that any of the antibiotic agents indicated herein in connection with the methods of the invention, may be used as well, for the kits of the invention.

In all of said test kits said means for collecting a sample to be tested can be a swab, a pipette, or similar collection means and said incubation means can be a liquid or semisolid culture medium placed in a plate, test tube, a glass or plastic surface, a well, or on a strip of absorbent paper, or, similar means.

It should be appreciated that any version of the kit has been designed so as to allow the test to be run on a scanner and the results fed into the computer in real time. This will ensure that the entire information can be mailed directly to all concerned and that it will be stored intact for any future reference. According to one embodiment, the characterizing enzyme used as a functional and structural marker may be any one of any of the classes of beta-lactamase, alpha-amylase, beta-glucosidase, alpha-glucosidase, catalase, lipase, beta-xylosidase, beta-glucuronidase, beta-galactosidase, chondroitinsulfatase, gelatinase, collagenase and caseinase.

In one specific embodiment, the characterizing enzyme used may be beta-lactamase. According to this particular embodiment, the kits of the invention provide compounds that are useful for the detection of β-lactamase activity. The disclosed compounds include colored, colorogenic, compounds that produce a detectable optical response (for example, an increase, decrease or wavelength shift in absorption) when contacted with a β-lactamase. The compounds include a dye moiety effectively coupled to, such as covalently bonded to, a β-lactamase substrate moiety, such as a cephalosporin, a benzofuranone, a benzopyranone, an aceturate, a malonamate or a clavulanic acid moiety. The β-lactamase substrate moiety (“substrate moiety”) is a group of atoms in which at least one bond is cleaved when contacted by a β-lactamase. Cleavage of the substrate moiety of the disclosed compounds by a β-lactamase provides a detectable response, such as a detectable optical response, of the dye moiety, which either remains connected to the cleaved substrate moiety or separates from the cleaved substrate moiety. In some embodiments, cleavage of the substrate generates a free phenol (phenolate), thiophenol (thiophenolate) or amine group on the dye moiety, thereby causing a change in the electronic structure of the dye moiety that provides a detectable optical change.

Yet another embodiment of the present invention is directed to a kit in compartmental form, said kit comprising a compartment adapted to contain one or more arrays. For example, an array may contain different inhibitory agents (for example, antibiotic agents), different recognition-agents (antibodies) specific for a certain characterizing enzyme, or both, cell inhibitory agents and recognition-agents. As indicated herein before, the inhibitory agents (antibiotic agents) or the antibodies are spatially arranged in a predetermined and separated location in the array. For example, an array may be a plurality of vessels (test tubes), plates, micro-wells in a micro-plate, each containing a different inhibitory agent or antibody. An array may also be any solid support holding in distinct regions (dots, lines, columns) different and known inhibitory agents or antibodies.

A solid support suitable for use in the kits of the present invention is typically substantially insoluble in liquid phases. Solid supports of the current invention are not limited to a specific type of support. Rather, a large number of supports are available and are known to one of ordinary skill in the art. Thus, useful solid supports include solid and semi-solid matrixes, such as aerogels and hydrogels, resins, beads, biochips (including thin film coated biochips), microfluidic chip, a silicon chip, multi-well plates (also referred to as microtitre plates or microplates), membranes, filters, conducting and nonconducting metals, glass (including microscope slides) and magnetic supports. More specific examples of useful solid supports include silica gels, polymeric membranes, particles, derivatized plastic films, glass beads, cotton, plastic beads, alumina gels, polysaccharides such as Sepharose, nylon, latex bead, magnetic bead, paramagnetic bead, superparamagnetic bead, starch and the like.

It should be further noted that any of the reagents included in any of the methods and kits of the invention may be provided as reagents embedded, linked, connected, attached placed or fused to any of the solid support materials described above. For example, the assay reagents in Example 3 are provided in a strip, and in Example 4, the reagents are provided in an impregnated filter paper.

The kits of the invention also include at least one additional component, for example, instructions for using the compound(s) in one or more methods, additional molecules (such as a β-lactamase, or any other characterizing enzyme, used as a positive control), reagents (such as a reaction buffer), or biological components (such as cells, or cell extracts). For example, known cells (e.g., prokaryotic or eukaryotic cells) which contain the characterizing enzyme, for example, the β-lactamase activity and/or at least one β-lactamase substrate, as well as compositions and reaction mixtures which contain such cells can be included in the kits.

In another embodiment, the kit may include compositions for the quantitative determination of the enzymatic activity of the characterizing enzyme, for example, a β-lactamase, in a sample. In an exemplary embodiment, the kit may comprise a sample containing a known amount of a β-lactamase (such as a solution containing the known amount of β-lactamase or cells expressing known amounts of the β-lactamase). The detectable product may be measured and compared to a control as a detectable optical response that is proportional to the amount of the β-lactamase in the sample.

Overuse of antibiotics, non-compliance with a full course of antibiotic treatment, routine prophylactic use and sub-therapeutic drug levels all contribute to the development of resistant strains of bacteria. There is thus a need in the art for identifying novel antibacterial agents. Therefore, in a further aspect, the present invention provides a rapid screening method for identification of novel antibiotic agents specifically inhibiting the growth of a cell expressing a characterizing enzyme. This screening method uses the specific characterizing enzyme as a functional marker for cell viability, as defined by any of the methods of the invention.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

Disclosed and described, it is to be understood that this invention is not limited to the particular examples, process steps, and materials disclosed herein as such process steps and materials may vary somewhat. It is also to be understood that the terminology used herein is used for the purpose of describing particular embodiments only and not intended to be limiting since the scope of the present invention will be limited only by the appended claims and equivalents thereof.

It must be noted that, as used in this specification and the appended claims, the singular forms “a”, “an” and “the” include plural referents unless the content clearly dictates otherwise.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The following Examples are representative of techniques employed by the inventor in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

Unless defined otherwise, all technical and scientific terms used herein have the same meaning as commonly understood by one of ordinary skill in the art to which this invention is related. The following terms are defined for purposes of the invention as described herein.

### Examples

### Experimental Procedures

Reagents
Nutrient broth and Nutrient Agar were purchased from Difco (cat. No. #233000 and #211665, respectively).
Mueller Hinton agar—purchased from Difco (cat. No. 225250).
Assay Reagent solution—50 mM potassium iodide and 10 mM iodine in 0.75% aqueous starch solution
L-alanine—was used for spore germination (purchased from Fluka, cat no. 29236).

Antibiotics
Phenoxymethylpenicillin [Penicillin V] (purchased from Sigma cat. No. P4807).

BBL antibiotic sensitivity testing disks were used for sensitivity profiling were placed in respective test tubes:

Cloxacillin 1 μg (Cat. No. 230737), Doxycycline 30 μg (Cat. No. 230777), Erythromycin 15 μg (cat. No. 230793) and Gentamicin 10 μg (cat. No. 231299).

Preparation of Antibodies Specific for B. cereus β-Lactamase (Penicillinase)

Enzyme Preparation

The penicillinase used for immunization was prepared from the culture supernatant of strain 569/H of B. cereus. This mutant strain, which produces penicillinase constitutively, has been derived from the inducible penicillinase-forming B. cereus 569. Preparation of the enzyme was described previously by the present inventor [Citri, N. et al., The Journal of Biological Chemistry 235(12): 3454-3459 (1960)]. Briefly, culture was started from spores inoculated into a medium consisting of Difco Peptone (1%), Bovril Meat Extract (0.3%), and sodium chloride (0.2). After reaching the logarithmic phase, the cells were transferred to a casein hydrolysate-citrate medium, and dispensed in 500 ml lots into 2-liter Erlenmeyer flasks. The casein hydrolysate-citrate medium cultures were incubated at 35° in a rotary type shaker for 6 to 8 hours. The supernatant was then collected by centrifugation (3000 r.p.m., 10 minutes), adjusted to pH 5, and percolated through a column of fine diatomaceous earth (Celite 535). The filtrate was found to be free of penicillinase activity and was discarded. The column was washed with twice-distilled water until no material absorbing in the 260- to 280-mμ range of the spectrum could be detected in the eluate. The enzyme was then gradually eluted with a solution consisting of 1 M NaCl and 0.1 M sodium citrate, adjusted to pH 8.5. Most of the activity was found in a small fraction, about 0.1 of the original volume of the eluate. This fraction was subjected to dialysis, at 2°, against 50 volumes of 0.001 M phosphate buffer, pH 7, for 4 hours.

Antibody Preparation

Preparation of anti-penicillinase antibodies was previously described by the present inventor [Citri, N; et al. Nature 190 (478):1010-1011 (1961)]. Briefly neutralizing antiserum was prepared by immunizing rabbits with a highly purified preparation of exopenicillinase produced by strain 569/H of B. cereus. Twenty mg of the enzyme were administered with Freund's adjuvant in three intramuscular injections at ten-day intervals. The antiserum thus prepared was found to be a convenient source of polyclonal antibodies and it was used without further purification as an ‘antibody preparation’ with the specificity required for recognition of the SF-marker [antigen enzyme] and for effective neutralization [inhibition] of its activity.

Without further elaboration, it is believed that one skilled in the art can, using the preceding description, utilize the present invention to its fullest extent. The following preferred specific embodiments are, therefore, to be construed as merely illustrative, and not limitative of the claimed invention in any way.

Standard microbiological protocols known in the art not specifically described herein are generally followed essentially as in Manual of Clinical Microbiology, Fourth edition, Editors Edwin H. Lennette, American Society for Microbilology, Washington. D. C. 1985.

### Example 1

### Detection of Bacillus cereus in Soil and Direct Determination of its Susceptibility Profile

In order to perform a combined characterization of bacteria identification and antibiotic sensitivity profiling, the inventor used a strain of Bacillus cereus expressing the characterizing enzyme β-lactamase (penicillinase) that is used herein as a structural-functional marker (SF-marker).

A colony of strain B of Bacillus cereus was dispersed in 0.5 gm of garden soil suspended in 3 ml of distilled water. Samples of the suspension, 0.3 ml each, were placed in 5 test, tubes, each containing 0.5 ml nutrient broth [double strength] spiked with 1.0 mcg cloxacillin, and each supplemented as listed in Table 1 below. After 10 min. at 30° C. the test was initiated by the addition to each test tube of 0.1 ml of the Assay Reagent solution containing the substrate, phenoxymethylpenicillin [10 mg/mL]. The time required for complete decolorization of the starch-iodine complex by the product of the catalytic reaction was recorded as shown in Table 1.

TABLE 1
Sensitivity profile of B. cereus using β-lactamase as a structural-
functional marker (SF-marker)

| | Sample # | | | | |
|---|---|---|---|---|---|
| | 1 | 2 | 3 | 4 | 5 |
| Additions | None | Antibody* | Gentamicin | Doxycyclin | Erythro- |
| | | | | | mycin |
| Decolorization | 47 | 315 | 48 | 815 | >850 |
| time [seconds] | | | | | |

Since the activity of the enzyme is inversely proportional to the decolorization time it will noted that samples 2, 4, and 5 were inhibited. The suppression of the activity by the antibody [as first described by Citri (1961) ibid.], although partial, indicates that the antibody recognized the enzyme as the product of strain B. This strain is now found to be resistant to gentamicin, which is shown to have no effect on synthesis of the SF marker. The test reveals that strain B is sensitive to doxycyclin and erythromycin.

The above example serves to illustrate the advantage of an inducible enzyme serving as an SF marker, in the present case the marker being and inducible β-lactamase, an enzyme which hydrolyses penicillin and many other β-lactams antibiotics. Since the biosynthesis of β-lactamase is induced by β-lactams, in the present case by cloxacillin, the initial activity, namely the activity before induction is close to zero and consequently inhibition of activity gain, as compared to that of the uninhibited control becomes evident after a very short incubation.

### Example 2

### of spores of a Constitutive Amylase Forming Bacillus subtilis

The inventor next examined a further characterizing enzyme, the amylase, as an SF-marker for Bacillus subtilis. A suspension of spores of Bacillus subtilis was heated [80° C., for ten min.] and dispersed in soil and tested essentially as in Example 1, except for the following changes: the β-lactams, namely cloxacillin and penicillin V, were omitted, whereas a germinant [L-alanine, 100 μl ] was added to the nutrient broth. The assay was carried out as indicated in Table 1.

Whereas the composition of the reagent and the mode of assay are the same in Examples 1 and 2, the activities assayed are unrelated. In the former, the decolorization of the starch-iodine complex is due to the uptake of iodine by the product of the β-lactamase reaction, whereas in the latter the decolorization is caused by the hydrolysis of starch brought about by the action of amylase.

This Example provides an illustration of the advantage of an enzyme secreted by a spore former. In the present Example the heat resistance of the bacterial spore allowed us to inactivate the enzyme initially present and thus to increase by a large factor the activity gain.

### Example 3

### Detection and Recording Kit for Field Use

The inventor next examined different forms of contacting the reaction mixture (including the sample) with the substrate. For example, samples of the Bacillus cereus strain described in Example 1 are set up and distributed as indicated in Table 1, except for the assay reagents which are not added to the test tubes but, instead, used to impregnate a strip of absorbent paper. A micropipette or a cotton-wool sampler is dipped in the incubated test tube to collect a small volume of each sample for delivery onto a marked spot on said strip. Thus the decolorization step takes place on the strip which, after drying, serves as a permanent record of the results.

### Example 4

### Determination of the Susceptibility of an ESBL Related Infection of the Urinary Tract

The inventor further examined the characterization of sensitivity profiling of unknown cells present in a urine sample. A centrifuge pellet from the urine is spread on a Mueller-Hinton agar for disk susceptibility testing analogous to the conventional laboratory procedure, except for having plated the unprocessed specimen pellet rather than an isolated colony. Next, the antibiotic disks are deposited on the agar plate and incubation is initiated as in the standard procedure. The first change, namely direct plating, eliminates the overnight incubation intended for obtaining isolated colonies of a suspected pathogen. It will be noted that in ESBL (Extended Spectrum Beta-Lactamase) related infections, resistance is conferred by destruction of the antibiotic so that identification of the pathogen is irrelevant to the sensitivity profile of the infection. A second change, eliminating any following overnight incubation/s required for observing and recording the growth inhibition zones is as follows:

The antibiotic disks are deposited on the agar plates and incubation is initiated as in the standard procedure. However, at about 150-180 min incubation is interrupted, the disks removed and the plates covered with ‘fitted sheets’ of Whatman #3 filter paper impregnated with the Assay Reagent solution described by Example 1.

Within minutes the blue-black sheet will turn white except for zones of inhibition which will remain dark. The dark zones will be found to coincide with the inhibition zones observed after another overnight incubation if a conventional laboratory test with identical antibiotic disks is run in parallel.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A method for the identification and optionally characterization of prokaryotic or eukaryotic cells present in a test sample, wherein said cells express at least one characterizing enzyme, said method comprising the steps of:
a) providing an array comprising:
(i) at least one recognition-agent which specifically recognizes and binds said characterizing enzyme, wherein each of said specific recognition-agent/s is located in a defined position in said array; and optionally
(ii) at least one cell inhibitory agent, wherein each of said inhibitory agent/s is located in a defined position in said array;
b) contacting aliquots of said test sample with agent/s comprised in said array of (a) under conditions allowing formation and activity of said characterizing enzyme; and
c) determining the level of said enzymatic activity in samples contacted with agent/s comprised in said array of (a) by suitable means;
wherein diminished increase in the level of said enzymatic activity as compared to a suitable control, in a sample contacted with a cell inhibitory agent of (ii) is indicative of sensitivity of said cells to said inhibitory agent, and wherein a change in the level of said catalytic activity as compared to a suitable control, in a sample contacted with a recognition-agent of (i) indicates the specific recognition and binding of said characterizing enzyme by said recognition-agent and thereby provides the identification of said cell strain present in said tested sample.

2. The method according to claim 1, wherein said cell inhibitory agent of (ii) reduces cell viability.

3. The method according to claim 1, wherein said recognition-agent of (i) is an antibody specific for an enzyme characterizing a certain strain of cells and wherein specific binding of said antibody to said characterizing enzyme changes the catalytic activity of said enzyme.

4. (canceled)

5. The method according to claim 3, for the rapid identification of prokaryotic or eukaryotic cells present in a test sample, wherein said cells express at least one characterizing enzyme, said method comprising the steps of:
a) providing an array comprising at least one antibody which specifically recognizes and binds said characterizing enzyme, wherein said antibody is specific for an enzyme characterizing a certain strain of cells and wherein each of said specific antibodies is located in a defined position in said array;
b) contacting aliquots of said test sample with the antibodies comprised in said array of (a) under conditions suitable for enzymatic activity of said characterizing enzyme; and
c) determining the level of said enzymatic activity in samples contacted with antibodies comprised in said array of (a) by suitable means;
wherein a change in the level of said catalytic activity as compared to a suitable control, in samples contacted with antibody comprised in said array of (a) indicates the recognition and binding of said specific enzyme by said antibody and thereby the identification of said cell strain present in said tested sample.

6. The method according to claim 1, wherein said cells are bacterial cells.

7. The method according to claim 6, wherein said rapid characterization and identification is completed within a period of between 180 to 30 minutes.

8. The method according to claim 7, wherein said bacterial cells are spores and wherein said conditions suitable for enzyme formation include addition of a germinant capable of triggering germination of spores contained within said test sample.

9. The method according to claim 7, wherein conditions suitable for enzyme formation include addition of at least one inducer for induction of the expression of said characterizing enzymes by said cells.

10. The method according to claim 6, wherein said characterizing enzyme is selected from the group consisting of: beta-lactamase, alpha-amylase, beta-glucosidase, alpha-glucosidase, catalase, lipase, beta-xylosidase, beta-glucuronidase, beta-galactosidase, chondroitinsulfatase, gelatinase, collagenase and caseinase.

11. The method according to claim 6, wherein said cell inhibitory agent is an antibiotic agent.

12. A kit for the rapid characterization of prokaryotic or eukaryotic cells present in a test sample, wherein said cells express at least one characterizing enzyme, said kit comprises:
a) at least one means for collecting a sample to be tested;
b) at least one compartment containing an array comprising:
at least one recognition-agent which specifically recognizes and binds said characterizing enzyme, wherein said recognition-agent is specific for an enzyme characterizing a certain strain of cells and wherein each of said recognition-agent/s is located in a defined position in said array; and optionally
(ii) at least one cell inhibitory agent, wherein each of said agent/s is located in a defined position in said array.
c) at least one reagent necessary for enzyme formation;
d) at least one assay reagent for enabling detection of the catalytic activity of said characterizing;
e) at least one means for determining the catalytic activity of said characterizing enzyme; and
f) optionally, at least one control sample.

13. The kit according to claim 12, for performing a method for the identification and optionally characterization of prokaryotic or eukaryotic cells present in a test sample, wherein said cells express at least one characterizing enzyme, said method comprising the steps of:
a) providing an array comprising:
(i) at least one recognition-agent which specifically recognizes and binds said characterizing enzyme, wherein each of said specific recognition-agent/s is located in a defined position in said array; and optionally
(ii) at least one cell inhibitory agent, wherein each of said inhibitory agent/s is located in a defined position in said array;
b) contacting aliquots of said test sample with agent/s comprised in said array of (a) under conditions allowing formation and activity of said characterizing enzyme; and
c) determining the level of said enzymatic activity in samples contacted with agent/s comprised in said array of (a) by suitable means;
wherein diminished increase in the level of said enzymatic activity as compared to a suitable control, in a sample contacted with a cell inhibitory agent of (ii) is indicative of sensitivity of said cells to said inhibitory agent, and wherein a change in the level of said catalytic activity as compared to a suitable control, in a sample contacted with a recognition-agent of (i) indicates the specific recognition and binding of said characterizing enzyme by said recognition-agent and thereby provides the identification of said cell strain present in said tested sample.

14. (canceled)

15. The kit according to claim 12, for performing a method for the rapid identification of prokaryotic or eukaryotic cells present in a test sample, wherein said cells express at least one characterizing enzyme, said method comprising the steps of:
a) providing an array comprising at least one antibody which specifically recognizes and binds said characterizing enzyme, wherein said antibody is specific for an enzyme characterizing a certain strain of cells and wherein each of said specific antibodies is located in a defined position in said array;
b) contacting aliquots of said test sample with the antibodies comprised in said array of (a) under conditions suitable for enzymatic activity of said characterizing enzyme; and
c) determining the level of said enzymatic activity in samples contacted with antibodies comprised in said array of (a) by suitable means;
wherein a change in the level of said catalytic activity as compared to a suitable control, in samples contacted with antibody comprised in said array of (a) indicates the recognition and binding of said specific enzyme by said antibody and thereby the identification of said cell strain present in said tested sample.
